(19) United States
(12) Patent Application Publication
(10) Pub. No.: US 2007/0133512 A1
(43) Pub. Date: Jun. 14, 2007

(54) Composite services enablement of visual navigation into a call center

(75) Inventors: William V. Da Palma, Coconut Creek, FL (US); Baiju D. Mandalia, Boca Raton, FL (US); Victor S. Moore, Lake City, FL (US); Wendi L. Nusbickel, Boca Raton, FL (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/297,541

(22) Filed: Dec. 8, 2005

(51) Int. Cl. H04L 12/66

(52) U.S. Cl. 370/352

(57) ABSTRACT

Embodiments of the present invention provide a method, system and computer program product for deploying and delivering composite services in an NGN network. In one embodiment, a method for visually navigating a voice view of a call center composite service in a composite services enablement environment can include establishing on behalf of a caller to a single session for a call center composite service, both a voice channel of access to the single session, and also a visual channel of access for the single session. The method further can include receiving caller provided information over the visual channel of access for the call center session. The method yet further can include updating a model for the single session with the provided information. Finally, the method can include synchronizing the model with the voice channel of access so as to navigate a voice view for the voice channel according to the caller provided information updated to the model.

### BACKGROUND OF THE INVENTION

1. Field of the Invention

The present invention relates to the field of next generation networking (NGN) and more particularly to the deployment and delivery of composite services over an NGN network.

2. Description of the Related Art

Next generation networking (NGN) refers to emerging computing networking technologies that natively support data, video and voice transmissions. In contrast to the circuit switched telephone networks of days gone by, NGN networks are packet switched and combine voice and data in a single network. Generally, NGN networks are categorized by a split between call control and transport. Also, in NGN networks, all information is transmitted via packets which can be labeled according to their respective type. Accordingly, individual packets are handled differently depending upon the type indicated by a corresponding label.

The IP Multimedia Subsystem (IMS) is an open, standardized, operator friendly, NGN multimedia architecture for mobile and fixed services. IMS is a Voice over Internet Protocol (VoIP) implementation based upon a variant of the session initiation protocol (SIP), and runs over the standard Internet protocol (IP). Telecom operators in NGN networks offer network controlled multimedia services through the utilization of IMS. The aim of IMS is to provide new services to users of an NGN network in addition to currently available services. This broad aim of IMS is supported through the extensive use of underlying IP compatible protocols and corresponding IP compatible interfaces. In this way, IMS can merge the Internet with the wireless, cellular space so as to provide to cellular technologies ubiquitous access useful services deployed on the Internet.

Multimedia services can be distributed both within NGN networks and non-NGN networks, alike, through the use of markup specified documents. In the case of a service having a visual interface, visually oriented markup such as the extensible hypertext markup language (XHTML) and its many co-species can specify the visual interface for a service when rendered in a visual content browser through a visual content channel, for instance a channel governed by the hypertext transfer protocol (HTTP). By comparison, an audio interface can be specified for a service by voice oriented markup such as the voice extensible markup language (VoiceXML). In the case of an audio interface, a separate voice channel, for instance a channel governed according to SIP.

In many circumstances, it is preferred to configure services to be delivered across multiple, different channels of differing modalities, including the voice mode and the visual mode. In this regard, a service provider not always can predict the interactive modality through which a service is to be accessed by a given end user. To accommodate this uncertainty, a service can be prepared for delivery through each anticipated modality, for instance by way of voice markup and visual markup. Generating multiple different markup documents to satisfy the different modalities of access, however, can be tedious. In consequence, merging technologies such as the XHTML+VoiceXML (X+V) have been utilized to simplify the development process.

Specifically, X+V represents one technical effort to produce a multimodal application development environment. In X+V, XHTML and VoiceXML can be mixed in a single document. The XHTML portion of the document can manage visual interactions with an end user, while the VoiceXML portion of the document can manage voice interactions with the end user. In X+V, command, control and content navigation can be enabled while simultaneously rendering multimodal content. In this regard, the X+V profile specifies how to compute grammars based upon the visual hyperlinks present in a page.

Processing X+V documents, however, requires the use of a proprietary browser in the client devices utilized by end users when accessing the content. Distributing multimedia services to a wide array of end user devices, including pervasive devices across NGN networks, can be difficult if one is to assume that all end user devices are proprietarily configured to handle X+V and other unifying technologies. Rather, at best, it can only be presumed that devices within an NGN network are equipped to process visual interactions within one, standard channel of communication, and voice interactions within a second, standard channel of communication.

Thus, despite the promise of X+V, to truly support multiple modalities of interaction with services distributed about an NGN or, even a non-NGN network, different channels of communications must be established for each different modality of access. Moreover, each service must be separately specified for each different modality. Finally, once a session has been established across one modality of access to a service, one is not able to change mid-session to a different modality of access to the same service within the same session. As a result, the interactions across different channels accommodating different modalities of interaction remain unsynchronized and separate. Consequently, end users cannot freely switch between modalities of access for services in an NGN network.

### BRIEF SUMMARY OF THE INVENTION

Embodiments of the present invention address deficiencies of the art in respect to deploying and delivering a service to be accessed through different channels of access in an NGN network, and provide a novel and non-obvious method, system and apparatus for deploying and delivering composite services in an NGN network. As used herein, a composite service is a service deployed across an NGN network that has been enabled to be accessed through multiple, different modalities of access in correspondingly different channels while maintaining the synchronization of the state of the service between the different channels of access.

In a first embodiment of the invention, a method for visually navigating a voice view of a call center composite service in a composite services enablement environment can include establishing on behalf of a caller to a single session for a call center composite service, both a voice channel of access to the single session, and also a visual channel of access for the single session. The method further can include receiving caller provided information over the visual channel of access for the call center session. The method yet further can include updating a model for the single session with the provided information. Finally, the method can include synchronizing the model with the voice channel of access so as to navigate a voice view for the voice channel according to the caller provided information updated to the model.

In another embodiment of the invention, a call center can include a composite service enabling data processing system including channel servlets enabled to establish for a single session, multiple different channels of access to a call center composite service. The composite service enabling data processing system further can include a location registry including a table of entries associating the different channels of access with the single session for the composite service. The composite service enabling data processing system also can include a model servlet configured for coupling to a model for the single session, for modifying state data in the model for the single session, and to synchronize views for each of the different channels of access to the composite service responsive to changes detected in the model. Notably, call center visual navigation logic can be provided. The call center visual navigation logic can include program code enabled to traverse a call tree for a voice view of the single session over a voice channel of access to the session, based upon information provided in a visual view over a visual channel of access for the single session.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of an IMS configured for use with a data processing system arranged to deploy and deliver composite services in an NGN network;

FIG. 2 is a schematic illustration of a data processing system arranged to deploy and deliver composite services in an NGN network;

FIG. 3 is a flow chart illustrating a process for delivering composite services in an NGN network;

FIG. 4 is a schematic illustration of a composite services enablement environment enabled for visual navigation in a call center; and,

FIG. 5 is a flow chart illustrating a process for visually navigating a call tree session in a call center hosted in the composite services enablement environment of FIG. 4.

### DETAILED DESCRIPTION OF THE INVENTION

Embodiments of the present invention provide a method, system and computer program product for delivering composite services in an NGN network. In accordance with an embodiment of the present invention, different channels of access to a service can be established for accessing a service through corresponding different modalities of access including voice and visual modes. Specifically, interactions with a service within a session can be provided across selected ones of the different channels, each channel corresponding to a different modality of access to the service. In the case of a voice modality and a visual modality, a separate markup document can be utilized in each selected channel according to the particular modality for that channel.

Importantly, each channel utilized for accessing a service within a session can be associated with each other channel accessing the service within the same session. In consequence, the state of the service stored within a model in a model-view-controller architecture—can be maintained irrespective of the channel used to change the state of the service. Moreover, the representation of the service can be synchronized in each view for the selected ones of the different channels. As such, an end user can interact with the service in a single session across different channels of access using different modalities of access without requiring burdensome, proprietary logic deployed within a client computing device.

In accordance with the present invention, the visual navigation of a call tree for a call center session hosted within the composite services environment can be supported. In this regard, a session can be established for a call center service which can provide both a voice view of the session provided by an interactive voice response system and a visual view provided by a content server for the session. Incoming calls can visually navigate the view of the session over a visual channel of access in response to which the view of the session over the voice channel of access to the session can advance. In this way, callers to the call center service need not tediously traverse a call tree by voice when the different nodes of the call tree can be satisfied through a visual interface.

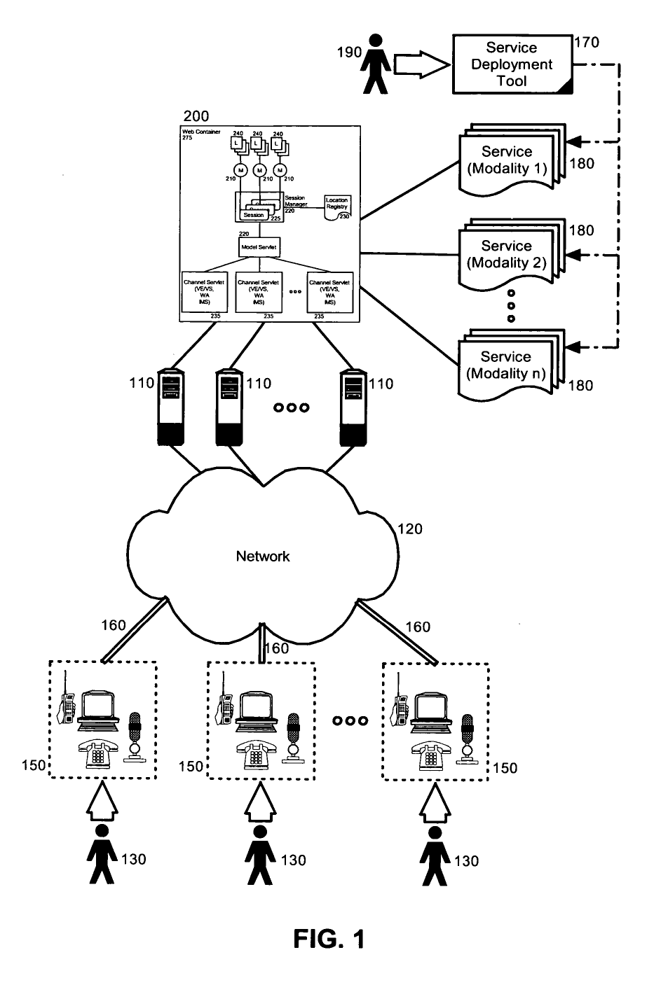

Advantageously, the system of the present invention can be embodied within an IMS in a NGN network. In illustration, FIG. 1 is a pictorial illustration of an IMS configured for use with a data processing system enabled to establish a voice channel of access to a session for a composite service from a visual channel of access to the session in an NGN network. As shown in FIG. 1, a composite service enablement data processing system 200 can be arranged to deploy and deliver a composite multimedia service 180 in an NGN network 120. As used herein, a “composite multimedia service” can be a service configured to be accessed through multiple different views of different modalities across correspondingly different channels of communications.

More specifically, the composite multimedia service 180 can be accessed through several different modalities, including a visual mode, an instant messaging mode and a voice mode. Each modality of access can be produced by a developer 190 through the use of a service deployment tool 170. The service deployment tool 170 can be configured to produce the different modalities of access for the composite multimedia service 180, including visual markup to provide visual access to the composite multimedia service 180, and voice markup to provide audible access to the composite multimedia service 180.

One or more gateway server platforms 110 can be coupled to the composite service enablement data processing system 200. Each of gateway server platforms 110 can facilitate the establishment of a communication channel for accessing the composite multimedia service 180 according to a particular modality of access. For example, the gateway server platforms 110 can include a content server such as a Web server enabled to serve visual markup for accessing the composite multimedia service 180 over the NGN network 120 through a visual mode. Likewise, the gateway server platforms 110 can include a voice server enabled to provide audible access to the composite multimedia service 180 over the NGN network 120 through an audible mode.

End users 130 can access the composite multimedia service 180 utilizing any one of a selection of client access devices 150. Application logic within each of the client access devices 150 can provide an interface for a specific modality of access. Examples include a content browser within a personal computing device, an audible user interface within a pervasive device, a telephonic user interface within a telephone handset, and the like. Importantly, each of the provided modalities of access can utilize a separate one of multiple channels 160 established with a corresponding gateway server platform 110 over the network 120 for the same session with the composite multimedia service 180. In this regard, a session with the composite multimedia service 180 can subsist across the multiple channels 160 to provide different modalities of access to the composite multimedia service 180 for one of the end users 130.

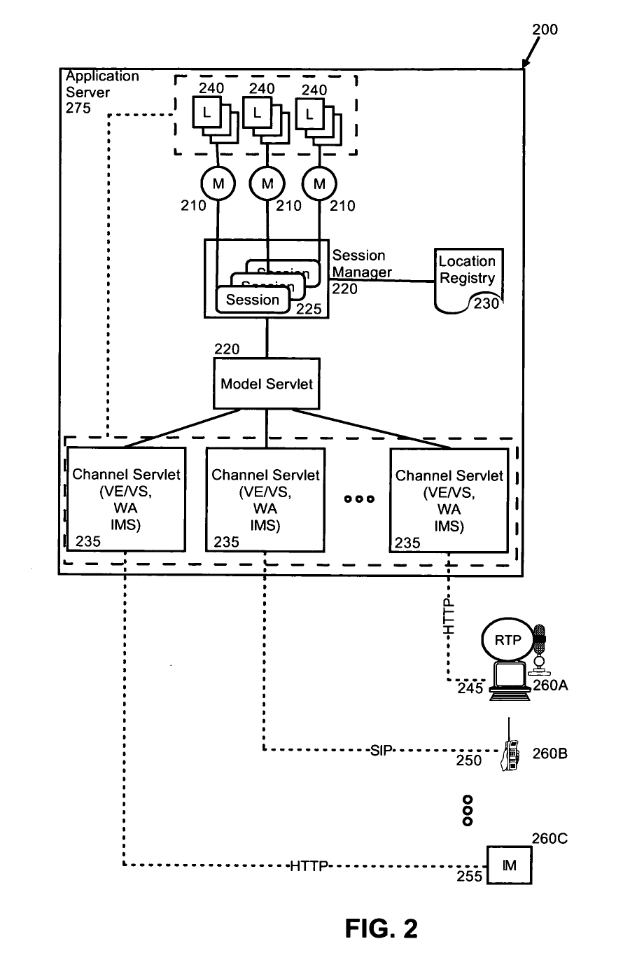

In more particular illustration, FIG. 2 is a schematic illustration of the composite service enablement data processing system 200 of FIG. 1. The composite service enablement data processing system 200 can operate in an application server 275 and can include multiple channel servlets 235 configured to process communicative interactions with corresponding sessions 225 for a composite multimedia service over different channels of access 245, 250, 255 for different endpoint types 260A, 260B, 260C in an NGN network. In this regard, the channel servlets 235 can process voice interactions as a voice enabler and voice server to visual endpoint 260A incorporating a voice interface utilizing the Real Time Protocol (RTP) over HTTP, or a voice endpoint 260B utilizing SIP. Likewise, the channel servlets 235 can process visual interactions as a Web application to a visual endpoint 160A. As yet another example, the channel servlets 235 can process instant message interactions as an instant messaging server to an instant messaging endpoint 260C.

More specifically, the channel servlets 235 can be enabled to process HTTP requests for interactions with a corresponding session 225 for a composite multimedia service. The HTTP requests can originate from a visual mode oriented Web page over a visual channel 245, from a visual mode oriented instant messaging interface over an instant messaging channel 255, or even in a voice mode over a voice channel 250 enabled by SIP. Similarly, the channel servlets 235 can be enabled to process SIP requests for interactions with a corresponding session 225 for a composite multimedia service through a voice enabler which can include suitable voice markup, such as VoiceXML and call control extensible markup language (CCXML) coupled to a SIPlet which, in combination, can be effective in processing voice interactions for the corresponding session 225 for the composite multimedia service, as it is known in the art.

Each of the channel servlets 235 can be coupled to a model servlet 220. The model servlet 220 can mediate interactions with a model 210 for an associated one of the sessions 225. Each of the sessions 225 can be managed within a session manager 220 which can correlate different channels of communication established through the channel servlets 235 with a single corresponding one of the sessions 225. The correlation of the different channels of communication can be facilitated through the use of a coupled location registry 230. The location registry 230 can include a table indicating a host name of systems and channels active for the corresponding one of the sessions 225.

The model servlet 215 can include program code enabled to access a model 210 for a corresponding session 225 for a composite multimedia service providing different channels of access 245. 250, 255 through different endpoints 260A, 260B, 260C. For instance, the model 210 can be encapsulated within an entity bean within a bean container. Moreover, the model 210 can store session data for a corresponding one of the sessions 225 irrespective of the channel of access 245, 250, 255 through which the session data for the corresponding one of the sessions 225 is created, removed or modified.

Notably, changes in state for each of the sessions 225 for a composite multimedia service can be synchronized across the different views 260 for the different channels of access 245, 250, 255 through a listener architecture. The listener architecture can include one or more listeners 240 for each model 210. Each listener can correspond to a different channel of access 245, 250, 255 and can detect changes in state for the model 210. Responsive to detecting changes in state for the model 210 for a corresponding one of the sessions 225 for a composite multimedia service, a listener 240 can provide a notification to subscribing view 260 through a corresponding one of the channel servlets 235 so as to permit the subscribing views 260 to refresh to incorporate the detected changes in state for the model 210.

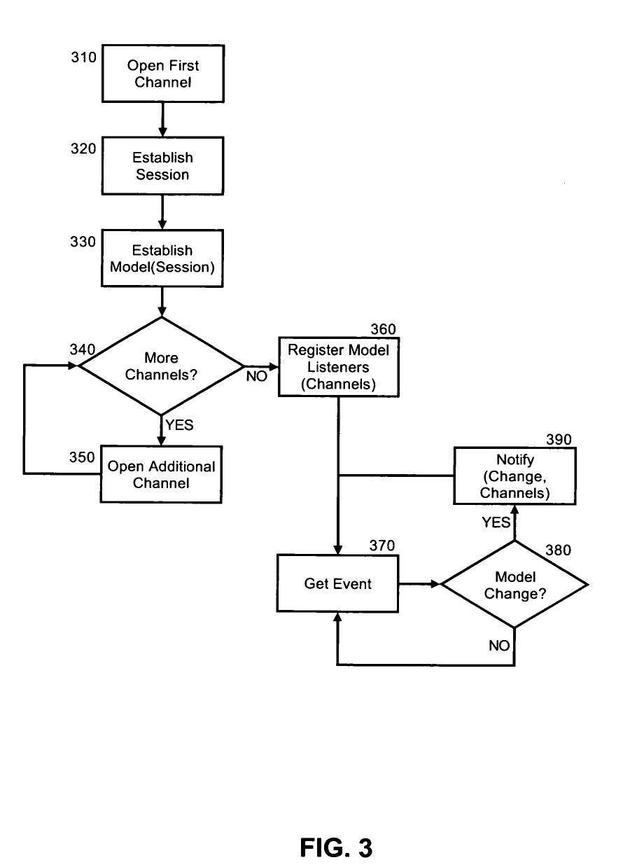

FIG. 3 is a flow chart illustrating a process for managing multiple channels of access to a single session for a composite service in the data processing system of FIG. 2. Beginning in block 310, a first channel of access can be opened for the composite multimedia service and a session can be established in block 320 with the composite multimedia service. Data for the session can be stored in a model for the session which can be established in block 330. If additional channels of access are to be established for the session in decision block 340, the process can continue in block 350. In block 350, an additional channel of access can be established for the same session for as many additional channels as required.

When no further channels of access are to be established in decision block 340, in block 360 a listener can be registered for each established channel of access for the session. Subsequently, in block 370 events can be received in each listener. In decision block 380, when a model change is detected, in block 390, the model change can be provided to each endpoint for selected ones of the established channels of access. In consequence, the endpoints can receive and apply the changes to corresponding views for the selected ones of the established channels of access for the same session, irrespective of the particular channel of access through which the changes to the model had been applied.

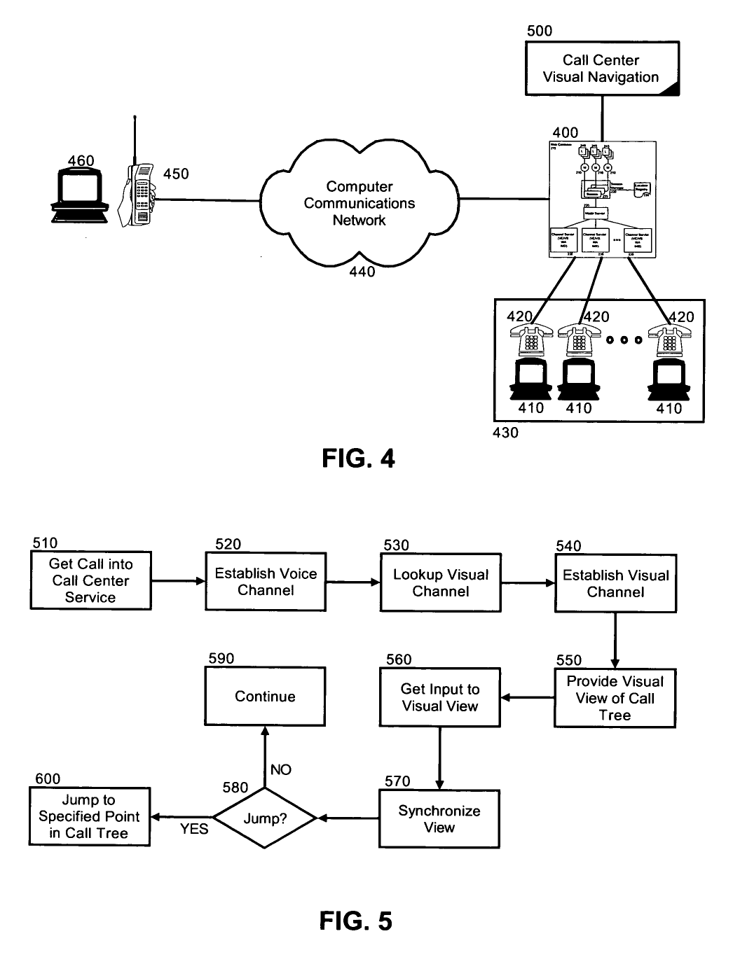

Notably, the visual navigation of a call tree for a call center session hosted within the composite services environment can be supported. In illustration, FIG. 4 is a schematic illustration of a composite services enablement environment enabled for visual navigation in a call center. As shown in FIG. 4, a composite services enablement data processing system 400 can support a call center service 430. The call center service 430 can provide a voice view 420 of a call tree. In addition, the call center service 430 can provide a visual view 410 of the call tree. For example, the call center service 430 can render a visual hierarchy of the call tree with activatable nodes. Call center visual navigation logic 500 can be coupled to the call center service 430 and can provide logic for permitting the visual navigation of the call tree through the visual view 410.

In operation, a caller 450 can establish a voice channel of access to a session in the call center service 430 over the computer communications network 440. The call center service 430 initially can provide a voice view 420 of the call tree for the call center service 430. Notwithstanding, an additional channel of access can be established for the session for a visual end point 460 associated with the caller 450. Consequently, the call center visual navigation logic 500 can provide to the visual end point 460 a visual view 410 of the call tree. Through the visual end point 460, information can be provided to the call center service 430 which information can be synchronized to the voice view 420. For instance, a node in the visual hierarchy can be selected to indicate a position in the call tree. As such, the call tree can be traversed without requiring the audible provision of the information through the voice view 420 for the call tree. In this way, the caller 450 can more rapidly arrive at a node in the call tree without first having to tediously traverse the call tree exclusively through the voice view 420 for the call tree.

In further illustration, FIG. 5 is a flow chart illustrating a process for visually navigating a call tree session in a call center hosted in the composite services enablement environment of FIG. 4. Beginning in block 510, a call can be received in the call center service resulting in the creation of a session for the caller with the call center service. In block 520, a voice channel of access can be established for the session. Additionally, in block 530, a visual channel of access can be identified for the caller and in block 540, a visual channel of access to the session can be provided to the caller. In block 550, a visual view of a call tree for the session can provided, for instance, represented by a set of fields in a form representing information to be provided audibly through the voice channel of access to the session.

In block 560, input can be received in the visual view and provided to the composite services enablement environment for updating the model associated with the session. In block 570, the listeners for the model can detect the update and synchronize the views for respective channels of access to the session, including the voice channel of access to the session. As such, in decision block 580 it can be determined whether the information provided through the visual view is sufficient to advance the call tree to an interior node whilst skipping intervening nodes configured to prompt the caller for the information already provided through the visual view. If not, the process can continue in block 590 without advancing through the call tree. However, if so, in block 600 the call tree can be traversed to an interior portion thereby skipping the intervening nodes configured to prompt the caller for the information provided through the visual view.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for visually navigating a voice view of a call center composite service in a composite services enablement environment, the method comprising:
establishing on behalf of a caller to a single session for a call center composite service, both a voice channel of access to the single session, and also a visual channel of access for the single session;
receiving caller provided information over the visual channel of access for the call center session;
updating a model for the single session with the provided information; and,
synchronizing the model with the voice channel of access so as to navigate a voice view for the voice channel according to the caller provided information updated to the model.

2. The method of claim 1, wherein establishing on behalf of a caller to a single session for a call center composite service, both a voice channel of access to the single session, and also a visual channel of access for the single session, comprises establishing on behalf of a caller to a single session for a call center composite service in a next generation networking (NGN) network, both a voice channel of access to the single session, and also a visual channel of access for the single session.

3. The method of claim 1, wherein receiving caller provided information over the visual channel of access for the call center session, comprises:
providing a form based visual view to the caller over the visual channel; and,
accepting a submission by the caller of information provided in the form.

4. The method of claim 1, wherein synchronizing the model with the voice channel of access so as to navigate a voice view for the voice channel according to the caller provided information updated to the model, comprises:
maintaining the state for the model;
creating listeners for updated to the state of the model;
detecting changes in the state of the model in the listeners; and,
updating the voice view for the voice channel of access to the session responsive to detecting the changes of state of the model in the listeners.

5. A call center comprising:
a composite service enabling data processing system comprising a plurality of channel servlets enabled to establish for a single session, multiple different channels of access to a composite service, a location registry comprising a table of entries associating the different channels of access with the single session for the composite service, and a model servlet configured for coupling to a model for the single session, for modifying state data in the model for the single session, and to synchronize views for each of the different channels of access to the composite service responsive to changes detected in the model;
wherein the composite service is a call center composite service.

6. The system of claim 5, further comprising call center visual navigation logic comprising program code enabled to traverse a call tree for a voice view of the single session over a voice channel of access to the session, based upon information provided in a visual view over a visual channel of access for the single session.

7. The system of claim 5, wherein the channel servlets comprise a voice enabler and voice server enabled to establish for the single session, a communications channel for a voice channel of access to the composite service.

8. The system of claim 5, wherein the channel servlets, model servlet and call center composite service are disposed in a Web container.

9. The system of claim 5, wherein the channel servlets, model servlet and call center composite service are disposed in an Internet protocol (IP) multimedia subsystem (IMS) in a next generation networking (NGN) network.

10. A computer program product comprising a computer usable medium having computer usable program code for visually navigating a voice view of a call center composite service in a composite services enablement environment, the computer program product including:
computer usable program code for establishing on behalf of a caller to a single session for a call center composite service, both a voice channel of access to the single session, and also a visual channel of access for the single session;
computer usable program code for receiving caller provided information over the visual channel of access for the call center session;
computer usable program code for updating a model for the single session with the provided information; and,
computer usable program code for synchronizing the model with the voice channel of access so as to navigate a voice view for the voice channel according to the caller provided information updated to the model.

11. The computer program product of claim 10, wherein the computer usable program code for establishing on behalf of a caller to a single session for a call center composite service, both a voice channel of access to the single session, and also a visual channel of access for the single session, comprises computer usable program code for establishing on behalf of a caller to a single session for a call center composite service in a next generation networking (NGN) network, both a voice channel of access to the single session, and also a visual channel of access for the single session.

12. The computer program product of claim 11, wherein the computer usable program code for receiving caller provided information over the visual channel of access for the call center session, comprises:
computer usable program code for providing a form based visual view to the caller over the visual channel; and,
computer usable program code for accepting a submission by the caller of information provided in the form.

13. The computer program product of claim 12, wherein the computer usable program code for synchronizing the model with the voice channel of access so as to navigate a voice view for the voice channel according to the caller provided information updated to the model, comprises:
computer usable program code for maintaining the state for the model;
computer usable program code for creating listeners for updated to the state of the model;
computer usable program code for detecting changes in the state of the model in the listeners; and,
computer usable program code for updating the voice view for the voice channel of access to the session responsive to detecting the changes of state of the model in the listeners.
